(19) United States
(12) Patent Application Publication
(10) Pub. No.: US 2001/0034207 A1
(43) Pub. Date: Oct. 25, 2001

(54) Data delivery system, method of delivering data, and apparatus for delivering data

(75) Inventor: Hitoshi Matsui, Tokyo (JP)

Correspondence Address: OSTROLENK FABER GERB & SOFFEN, 1180 AVENUE OF THE AMERICAS, NEW YORK, NY, 100368403

(73) Assignee: NEC Corporation

(21) Appl. No.: 09/841,198

(22) Filed: Apr. 24, 2001

(30) Foreign Application Priority Data
Apr. 25, 2000 (JP) 124028/2000

(51) Int. Cl. H04B 5/00

(52) U.S. Cl. 455/41; 455/456; 455/414

(57) ABSTRACT

A data delivery system includes (a) drive-through facilities in which an automobile including a portable terminal having a function of making radio communication parks, (b) a communication device which makes radio communication with the portable terminal when the automobile parks in the drive-through facilities, and (c) a data delivery unit which receives a request of delivering data to the portable terminal, transmitted from the portable terminal through the communication device, and transmits requested data to the portable terminal through the communication device.

### BACKGROUND OF THE INVENTION

1. Field of the Invention

The invention relates to a data delivery system, a method of delivering data, and an apparatus for delivering data all of which downloads requested data to a terminal having a function of making radio communication.

2. Description of the Related Art

If a user wants to have new music and/or image data stored in a recording medium, a user conventionally had to purchase a commercially available recording medium storing music and/or image data which a user wanted to have. In these days, instead of purchasing such a recording medium, a user can have new music and/or image data by downloading such data into a user's recording medium.

In downloading of such data, a user sets his/her recording medium in a terminal equipped in a shop such as a CD shop or a drug store, decides a title of music and/or image data which he/she wants to have, and operates the terminal in a predetermined manner. Then, a data deliver server downloads his/her desired music and/or image data into his/her recording medium.

As an alternative, a user may download his/her desired music and/or image data into his/her recording medium through Internet.

In the first mentioned conventional system for downloading user's desired music and/or image data into a recording medium, a user had to inconveniently visit a shop. On the other hand, a data deliver company has to have facilities for downloading data into a recording medium, and prepare a shop and personnels for accounting, which needs much running costs.

In the above-mentioned conventional system for downloading user's desired data into a recording medium through Internet, a user can have his/her desired data without visiting a shop, and further can select his/her desired data among a lot of data.

However, it would be quite difficult to have a line rate sufficient for rapidly downloading data into a recording medium. In particular, it would take much time to download image data in comparison with music data, because image data is greater in data quantity than music data.

### SUMMARY OF THE INVENTION

In view of the above-mentioned problems, it is an object of the present invention to provide a data delivery system, a method of delivering data, and an apparatus for delivering data all of which make it possible to readily provide data requested by a user.

It is also an object of the present invention to provide a data delivery system, a method of delivering data, and an apparatus for delivering data all of which make it possible to deliver data in low costs for data providers and receive data in low costs for data receivers.

In one aspect of the present invention, there is provided a data delivery system including (a) drive-through facilities in which an automobile including a portable terminal having a function of making radio communication parks, (b) a communication device which makes radio communication with the portable terminal when the automobile parks in the drive-through facilities, and (c) a data delivery unit which receives a request of delivering data to the portable terminal, transmitted from the portable terminal through the communication device, and transmits requested data to the portable terminal through the communication device.

In the data delivery system in accordance with the present invention, the data delivery unit selects data among various data stored in a memory in response to a request transmitted from the portable terminal in an automobile, and transmits the requested data to the portable terminal through the communication device. Hence, a user in an automobile can download his/her desired data into a memory equipped in the portable terminal without going out of the automobile and more readily than visiting a shop and downloading his/her desired data into a recording medium there.

In the present invention, menu selection is carried out separately from downloading data into a recording medium. Menu selection can be carried out any time and anywhere. The above-mentioned request includes data indicative of selected menu.

It is preferable that the communication device makes radio communication with the portable terminal through small-powered radio wave or weak radio wave.

This enables data transmission at a higher rate than Internet, such as data transmission defined in IEEE 1394. This also ensures that a lot of data such as image data can be downloaded into a portable terminal more rapidly than downloading data through Internet.

In addition, if a user had a portable terminal including a hardware which can transmit data at a high rate, for instance, in accordance with IEEE 1394, he/she could download his/her desired data into the portable terminal, even if he/she did not have a hardware necessary for downloading data into a recording medium.

It is preferable that data stored in the data delivery unit can be updated through Internet.

For instance, the data delivery unit is comprised of (c1) a memory storing various data therein, and (c2) a controller which receives a request of delivering data to a portable terminal equipped in an automobile parking in drive-through facilities, reads requested data out of the memory, and transmits the thus read-out data to the portable terminal.

It is preferable that the controller receives data through Internet, and stores the thus received data into the memory.

It is preferable that the controller carries out accounting, based on an identification number transmitted from the portable terminal, after transmitting the data to the portable terminal.

In another aspect of the present invention, there is provided a method of delivering data, comprising the steps of (a) transmitting a request of delivering data to a portable terminal equipped in an automobile parking in drive-through facilities, to a data delivery unit, the step (a) being carried out by the automobile, (b) reading data requested by the portable terminal, out of a memory, the step (b) being carried out by the data delivery unit, and (c) transmitting data read out in the step (b) to the portable terminal, the step (c) being carried out by the data delivery unit.

The above-mentioned method presents the same advantages as those presented by the above-mentioned data delivery system.

It is preferable that the method further includes the step of (d) downloading received data in a memory equipped in the portable terminal, the step (d) being carried out by the portable terminal.

It is preferable that the portable terminal makes radio communication with the data delivery unit through a communication device in small-powered radio wave or weak radio wave.

There is still further provided a method of delivering data, including the steps of (a) transmitting a request of delivering data to a portable terminal equipped in an automobile, to a data delivery unit, the step (a) being carried out by the automobile, (b) reading data requested by the portable terminal, out of a memory, the step (b) being carried out by the data delivery unit, and (c) transmitting data read out in the step (b) to the portable terminal when the automobile parks in drive-through facilities, the step (c) being carried out by the data delivery unit.

In still another aspect of the present invention, there is provided a data delivery unit including (a) a memory storing various data therein, and (b) a controller which receives a request of delivering data to a portable terminal equipped in an automobile parking in drive-through facilities, reads requested data out of the memory, and transmits the thus read-out data to the portable terminal.

In accordance with the data delivery unit, in response to a request of delivering data, transmitted from the portable terminal, the controller transmits requested data to the portable terminal. Hence, it is possible to automatically transmit requested data without any operation to be carried out by personnels, and carry out accounting without any personnels.

It is preferable that the controller receives data through Internet, and stores the thus received data into the memory.

It is preferable that the controller carries out accounting, based on an identification number transmitted from the portable terminal, after transmitting the data to the portable terminal.

In yet another aspect of the present invention, there is provided a recording medium readable by a computer, storing a program therein for causing a computer to act as the above-mentioned data delivery unit.

The above and other objects and advantageous features of the present invention will be made apparent from the following description made with reference to the accompanying drawings, in which like reference characters designate the same or similar parts throughout the drawings.

### BRIEF DESCRIPTION OF THE DRAWINGS

FIG. 1 is a block diagram of a data delivery system in accordance with an embodiment of the present invention.

FIG. 2 is a block diagram of the data delivery unit and the data communication device in the data delivery system illustrated in FIG. 1.

FIG. 3 illustrates examples of recording mediums in which a program for accomplishing the data delivery system is to be stored.

### DESCRIPTION OF THE PREFERRED EMBODIMENTS

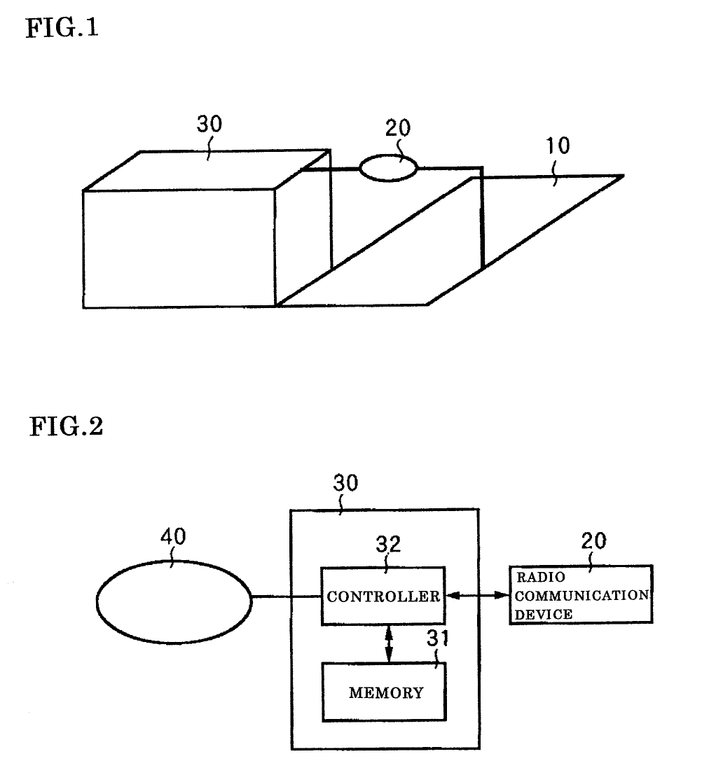

FIG. 1 illustrates a data delivery system in accordance with a preferred embodiment of the present invention.

The data delivery system is comprised of drive-through facilities 10, a radio communication device 20, and a data delivery unit 30.

The drive-through facilities 10 define a space in which an automobile (not illustrated) can park.

The radio communication device 20 can make radio communication with a portable terminal equipped in an automobile parking in the drive-through facilities 10, at a distance in the range of about 2 m to about 3 m through small-powered radio wave or weak radio wave. The portable terminal has a function of making radio communication. For instance, the portable terminal is comprised of a portable personal computer or a cellular phone.

The radio communication device 20 receives data transmitted from the portable terminal, and transmits the received data to the data delivery unit 30. Furthermore, the radio communication device 20 receives data addressed to the portable terminal, from the data delivery unit 30, and transmits the received data to the portable terminal.

The radio communication device 20 is arranged in the drive-through facilities 10.

FIG. 2 is a block diagram of an example of the data delivery unit 30.

The data delivery unit 30 is comprised of a memory 31 storing a lot of data therein, and a controller 32 which receives a request of delivering data to the portable terminal equipped in an automobile parking in drive-through facilities 10, transmitted from the portable terminal, reads the requested data out of the memory 31, and transmits the thus read-out data to the portable terminal through the radio communication device 20.

As the memory 31, there may be used a hard disk, which ensures both a data transmission rate of hundreds of Mbps, and sufficient memory capacity.

In addition, data stored in the memory 31 can be updated through Internet 40. Hence, it would be possible to provide latest music and/or image data to a user through unmanned facilities. As an alternative, it would be possible to provide data stored in the memory 31, to an Internet user through Internet 40.

A user may select data which he/she wants to download into his/her portable terminal, in the drive-through facilities 10. As an alternative, a user may select data through Internet network at a place other than the drive-through facilities 10, and can download his/her desired data into his/her portable terminal while his/her automobile is parking in the drive-through facilities 10.

Hereinbelow is explained an operation of the data delivery system illustrated in FIG. 1.

First, a user parks his/her automobile in the drive-through facilities 10.

Then, a user transmits a request of delivering his/her desired data to his/her portable terminal, by means of his/her portable terminal, to the data delivery unit 30 through the radio communication device 20 equipped in the drive-through facilities 10, through small-powered radio waves or weak radio waves. The request contains ID data inherent to a user and assigned to a user from the data delivery unit 30, and further contains a password in advance registered in the data delivery unit 30.

The request transmitted the user's portable terminal is received in the radio communication device 20 arranged at a distance of about 2 to 3 m away from a user's automobile, and then, is transmitted to the data delivery unit 30 from the radio communication device 20.

On receipt of the request from the user's portable terminal, the controller 32 in the data delivery unit 30 analyzes ID data and password contained in the request, and judges whether a user is a registered user or not.

If a user is not a registered one, the controller 32 transmits rejection of data delivery to the user's portable terminal through the radio communication device 20.

If a user is a registered one, the controller 32 transmits a list of data stored in the memory 31, to the user's portable terminal through the radio communication device 20.

Then, a user selects data which he/she wants to download into his/her portable terminal, among data displayed in a display screen of his/her portable terminal. Based on the selection of a user, the portable terminal transmits a selection signal to the radio communication device 20.

A user may select his/her desired data among data displayed in a display screen of his/her portable terminal as mentioned above. Instead, a user may in advance select his/her desired data among data displayed in a display screen through Internet network, in which case, the request of delivering data to a user's portable terminal is designed to include information about data selected by a user.

The radio communication device 20 receives the selection signal from the user's portable terminal, and transmits the received selection signal to the data delivery unit 30.

The controller 32 in the data delivery unit 30 reads data designated by the selection signal, out of the memory 31, and transmits the thus read-out data to the radio communication device 20.

The radio communication device 20 receives the data from the controller 32, and then, transmits the data into the portable terminal of a user whose automobile is now parking in the drive-through facilities 10. Thereafter, the portable terminal downloads the data transmitted from the radio communication device 20, into a memory equipped in the portable terminal.

Since image data such as one stored in a digital versatile disk (DVD) is in a few Giga bytes or greater, it would be necessary for both the data delivery unit 30 and the radio communication device 20 to have a data transmission rate significantly higher than a data transmission rate of Internet. For instance, image data stored in DVD for 120 minutes is in about 5 Giga bytes. In order to transmit such image data in about 1 to 2 minutes, the radio communication device 20 would have to have a data transmission rate in the range of 300 to 600 Mbps.

The data transmission rate in the range of 300 to 600 Mbps can be accomplished by making radio communication at a short distance through small-powered radio wave or weak radio wave by means of a radio interface which uses a radio frequency such as millimeter waves defined in IEEE 1394. Accordingly, the data delivery system in accordance with the embodiment can download a lot of data such as image data into a user's portable terminal in a shorter period of time in comparison with Internet.

Since an automobile a user drives is in the drive-through facilities 10, a communication distance between a user's portable terminal and the radio communication device 20 is in the range of about 2 to about 3 meters. Hence, even small-sized radio wave facilities such as one used in home multi-media system could ensure stable data transmission.

After data delivery to the user's portable terminal has been finished, there is carried out accounting in an electronic form between the data delivery unit 30 and the user's portable terminal. In accounting, data delivery fee is automatically withdrawn from a user's bank account which is in advance registered in the data delivery unit 30. Accordingly, it is not necessary to arrange personnels in the drive-through facilities 10 for collecting a fee from a user, and hence, it is possible to deliver user's desired data in an unmanned system.

Since a radio communication distance between the drive-through facilities 10 and the radio communication device 20 is in the range of about 2 to about 3 m, and radio communication between the drive-through facilities 10 and the radio communication device 20 is separated from public network, the user's terminal in an automobile parking in the drive-through facilities 10 can make radio communication only with the radio communication device 20. Hence, it would be impossible for a third party to illegally obtain data transmitted between the user's portable terminal and the data delivery unit 30.

As mentioned so far, the embodiment makes it possible to download user's desired music and/or image data into a user's portable terminal with the user staying in an automobile parking in the drive-through facilities 10. A user can download his/her desired data into his/her portable terminal with the same convenience as a convenience with which a user visits a fast-food shop by his/her automobile, makes an order without going out of his/her automobile, and receives foods.

The above-mentioned convenience is superior to a convenience with which a user visits a shop, sets his/her recording medium into a data communication terminal equipped in the shop, and downloads his/her desired music and/or image data into his/her recording medium. This is because the above-mentioned embodiment allows a user to walk only in a shorter period of time than the above-mentioned conventional manner.

In addition, a time necessary for downloading user's desired data into a recording medium in accordance with the above-mentioned embodiment is shorter than a time for doing the same through Internet.

In accordance with the embodiment, all the steps including the step of downloading user's desired data and the step of carrying out accounting can be carried out in an unmanned system controlled by a computer. Hence, it is no longer necessary to have a shop with personnels, which ensures reduction in running costs and 24 hours operation without days-off.

In addition, a user who has a hardware which is capable of accomplishing data transmission at a high rate such as hundreds of Mbps defined in IEEE 1394 would not be necessary to prepare a hardware use for data delivery from the data delivery unit 30 to a user's portable terminal.

Though radio communication is made between the data delivery unit 30 and the user's portable terminal in the above-mentioned embodiment, optic communication may be selected instead of radio communication.

A communication cable connector may be arranged in the drive-through facilities 10 at a place a user can reach when he/she parks his/her automobile in the drive-through facilities 10. By connecting his/her portable terminal to the connector through a cable, a user may make wire communication with the data delivery unit 30 through his/her portable terminal.

The control of the data delivery unit 30 may be accomplished as a program including various commands, and be presented through a recording medium readable by a computer.

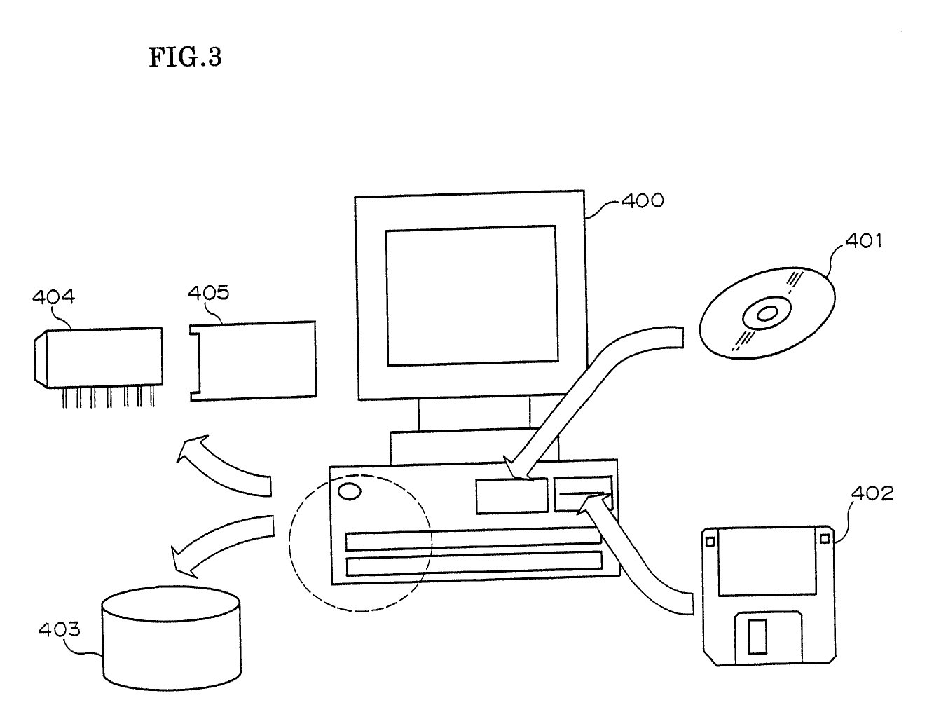

In the specification, the term “recording medium” means any medium which can record data therein. Examples of a recording medium are illustrated in FIG. 3.

The term “recording medium” includes, for instance, a disk-shaped recorder 401 such as CD-ROM (Compact Disk-ROM) or PD, a magnetic tape, MO (Magneto Optical Disk), DVD-ROM (Digital Video Disk-Read Only Memory), DVD-RAM (Digital Video Disk-Random Access Memory), a floppy disk 402, a memory chip 404 such as RAM (Random Access Memory) or ROM (Read Only Memory), EPROM (Erasable Programmable Read Only Memory), EEPROM (Electrically Erasable Programmable Read Only Memory), smart media (Registered Trade Mark), a flush memory, a rewritable card-type ROM 405 such as a compact flush card, a hard disk 403, and any other suitable means for storing a program therein.

A recording medium storing a program for accomplishing the above-mentioned apparatus may be accomplished by programming functions of the above-mentioned apparatuses with a programming language readable by a computer, and recording the program in a recording medium such as mentioned above.

A hard disc equipped in a server may be employed as a recording medium. It is also possible to accomplish the recording medium in accordance with the present invention by storing the above-mentioned computer program in such a recording medium as mentioned above, and reading the computer program by other computers through a network.

As a computer 400, there may be used a personal computer, a desk-top type computer, a note-book type computer, a mobile computer, a lap-top type computer, a pocket computer, a server computer, a client computer, a workstation, a host computer, a commercially available computer, and electronic exchanger, for instance.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

The entire disclosure of Japanese Patent Application No. 2000-124028 filed on Apr. 25, 2000 including specification, claims, drawings and summary is incorporated herein by reference in its entirety.

What is claimed is:

1. A data delivery system comprising:
(a) drive-through facilities in which an automobile including a portable terminal having a function of making radio communication parks;
(b) a communication device which makes radio communication with said portable terminal when said automobile parks in said drive-through facilities; and
(c) a data delivery unit which receives a request of delivering data to said portable terminal, transmitted from said portable terminal through said communication device, and transmits requested data to said portable terminal through said communication device.

2. The data delivery system as set forth in claim 1, wherein said communication device makes radio communication with said portable terminal through small-powered radio wave or weak radio wave.

3. The data delivery system as set forth in claim 1, wherein data stored in said data delivery unit can be updated through Internet.

4. The data delivery system as set forth in claim 1, wherein said data delivery unit is comprised of:
(c1) a memory storing various data therein; and
(c2) a controller which receives a request of delivering data to a portable terminal equipped in an automobile parking in drive-through facilities, reads requested data out of said memory, and transmits the thus read-out data to said portable terminal.

5. The data delivery system as set forth in claim 5, wherein said controller receives data through Internet, and stores the thus received data into said memory.

6. The data delivery system as set forth in claim 5, wherein said controller carries out accounting, based on an identification number transmitted from said portable terminal, after transmitting said data to said portable terminal.

7. A method of delivering data, comprising the steps of:
(a) transmitting a request of delivering data to a portable terminal equipped in an automobile parking in drive-through facilities, to a data delivery unit, said step (a) being carried out by said automobile;
(b) reading data requested by said portable terminal, out of a memory, said step (b) being carried out by said data delivery unit; and
(c) transmitting data read out in said step (b) to said portable terminal, said step (c) being carried out by said data delivery unit.

8. The method as set forth in claim 7, further comprising the step of (d) downloading received data in a memory equipped in said portable terminal, said step (d) being carried out by said portable terminal.

9. The method as set forth in claim 7, wherein said portable terminal makes radio communication with said data delivery unit through a communication device in small-powered radio wave or weak radio wave.

10. A method of delivering data, comprising the steps of:
(a) transmitting a request of delivering data to a portable terminal equipped in an automobile, to a data delivery unit, said step (a) being carried out by said automobile;
(b) reading data requested by said portable terminal, out of a memory, said step (b) being carried out by said data delivery unit; and
(c) transmitting data read out in said step (b) to said portable terminal when said automobile parks in drive-through facilities, said step (c) being carried out by said data delivery unit.

11. The method as set forth in claim 10, further comprising the step of (d) downloading received data in a memory equipped in said portable terminal, said step (d) being carried out by said portable terminal.

12. The method as set forth in claim 10, wherein said portable terminal makes radio communication with said data delivery unit through a communication device in small-powered radio wave or weak radio wave.

13. A data delivery unit comprising:
(a) a memory storing various data therein; and
(b) a controller which receives a request of delivering data to a portable terminal equipped in an automobile parking in drive-through facilities, reads requested data out of said memory, and transmits the thus read-out data to said portable terminal.

14. The data delivery unit as set forth in claim 13, wherein said controller receives data through Internet, and stores the thus received data into said memory.

15. The data delivery unit as set forth in claim 13, wherein said controller carries out accounting, based on an identification number transmitted from said portable terminal, after transmitting said data to said portable terminal.

16. A recording medium readable by a computer, storing a program therein for causing a computer to act as a data delivery unit, said data delivery unit comprising:
(a) a memory storing various data therein; and
(b) a controller which receives a request of delivering data to a portable terminal equipped in an automobile parking in drive-through facilities, reads requested data out of said memory, and transmits the thus read-out data to said portable terminal.

17. The recording medium as set forth in claim 16, wherein said controller receives data through Internet, and stores the thus received data into said memory.

18. The recording medium as set forth in claim 16, wherein said controller carries out accounting, based on an identification number transmitted from said portable terminal, after transmitting said data to said portable terminal.
